(19) United States
(12) Patent Application Publication
(10) Pub. No.: US 2008/0120094 A1
(43) Pub. Date: May 22, 2008

(54) SEAMLESS AUTOMATIC SPEECH RECOGNITION TRANSFER

(75) Inventors: Sujeet Mate, Tampere (FI); Sunil Sivadas, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/561,226

(22) Filed: Nov. 17, 2006

(51) Int. Cl. G10L 15/00; G10L 21/00

(52) U.S. Cl. 704/201; 704/231; 704/E15.045

(57) ABSTRACT

Provided are apparatuses and methods for efficiently transferring automatic speech recognition sessions from one engine to another. The user of a mobile device may initiate a speech recognition session on a first speech recognition engine and automatically transfer the session to a second speech recognition engine for seamless completion of the speech recognition session.

### TECHNICAL FIELD

Aspects of the invention relate generally to speech recognition. More specifically, aspects of the invention relate to seamless transferring of automatic speech recognition sessions from one speech recognition engine to another.

### BACKGROUND

A variety of mobile computing devices exist, such as personal digital assistants (PDAs), mobile phones, digital cameras, digital players, mobile terminals, etc. (hereinafter referred to as “mobile devices”). These mobile devices perform various functions specific to the device and are often able to communicate (via wired or wireless connection) with other devices. A mobile device may, for example, provide Internet access, maintain a personal calendar, provide mobile telephony, take digital photographs and provide speech recognition services. However, memory capacity is typically limited on mobile devices.

Automatic Speech Recognition (ASR) is a resource intensive service. Using an ASR system on resource constrained devices require employing light-weight algorithms and methodologies. An often suggested work around for resource constrain is using a client-server based architecture (also known as DSR, distributed speech recognition). In DSR, an ASR client resides on the computing device and the resource-intensive tasks are handled on a network based server. Thus, a client server based approach (DSR) maintains the convenience of a mobile ASR client, and enables the use of complex techniques at the server with very high resource availability.

However, a client-server network may not be available such as when a user is physically moving from a first location to a second location and dictating a memorandum or other document. For example, a user may begin a dictation at a first location such as in an automobile and continue/finish the dictation at a home or office located at a second location.

In addition, inefficiencies may arise as users may be forced to use only one ASR engine for all speech recognition services. Upon implementing a speech recognition service through a first ASR engine, it may be beneficial to switch to a different ASR engine that may be optimized for a particular speech recognition service. Moreover, because an ASR engine works in sequential manner switching ASR engines seamlessly must be accomplished in real-time which remains a problem in the art for which a solution has not been implemented.

For these and other reasons, there remains a need for an apparatus and method by which an ASR session may be seamlessly transferred from one ASR engine to another ASR engine in an efficient manner.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In an aspect of the invention, a method and apparatus is provided for efficient and seamless switching between ASR engines. For example, a mobile terminal may switch between a first ASR engine located on the mobile terminal to a second ASR engine located on a personal computer.

In an aspect of the invention, ASR state information may be used to create a state matrix in the first ASR engine. The matrix may be transferred to a second ASR engine during an ASR transfer enabling the second ASR engine to begin from the ending point of the first ASR engine.

In another aspect of the invention, the state matrix information may include data such as timing and acoustic and language model scores. The second ASR engine may utilize its own set of acoustic and language models to rescore a word lattice diagram.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of an exemplary communication system in which various aspects of the present invention may be implemented.

FIG. 2 illustrates an example of a mobile device in accordance with an aspect of the invention.

FIG. 3 illustrates a block diagram of a computing device in accordance with an aspect of the

FIG. 4 illustrates a block diagram of a speech recognition system in accordance with at least one aspect of the invention.

FIG. 5 illustrates an exemplary word lattice diagram in accordance with at least one aspect of the invention.

FIG. 6 illustrates an exemplary switching from a first ASR engine to second ASR engine in accordance with at least one aspect of the invention.

FIG. 7 illustrates a flow diagram illustrating the transfer from a first ASR engine to a second ASR engine in accordance with an aspect of the invention.

FIG. 8 illustrates an exemplary lattice and state information in accordance with an aspect of the invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention. It is noted that various connections are set forth between elements in the following description. In addition, it is further noted that these connections in general and, unless specified otherwise, may be direct or indirect and that this specification is not intended to be limiting in this respect.

Enabling seamless ASR session transfers provides for a pleasing user experience. In an aspect of the invention, each node in a network may have an ASR engine. The ASR engine may benefit from context information which includes both the ambience of the user and context of the dictated utterance. For example, in an embodiment the user may be interacting with the ASR engine in a hallway that contains high ambient noise. Receipt of the information regarding the noisy hallway may be utilized in applying suitable noise robust ASR techniques. When the user moves into his/her office, which may be relatively quiet, the ASR engine that the user is interacting with may use an algorithm suitable for high Signal to Noise Ratio (SNR). Seamless transfer of an ASR session in progress such as from one ASR engine located in the hallway to another ASR engine located in an office may be necessary for its usability in environments that require multiple and frequent transfer of ASR sessions between ASR engines.

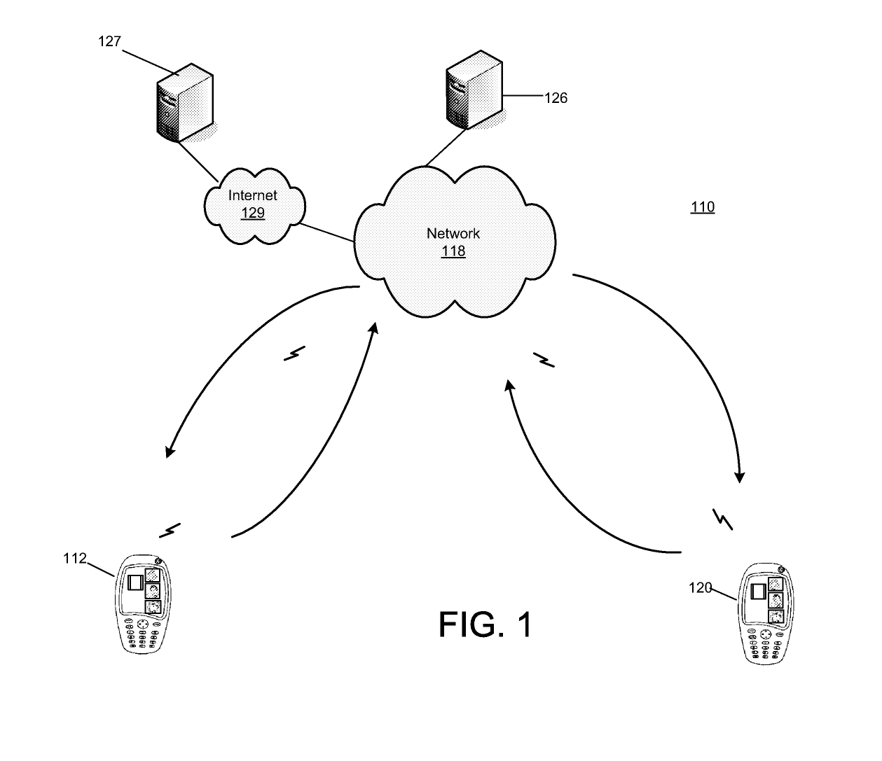

FIG. 1 illustrates an exemplary communication system 110 in which the systems and methods of the invention may be advantageously employed. One or more network-enabled mobile devices 112 and/or 120, such as a personal digital assistant (PDA), cellular telephone, mobile terminal, personal video recorder, portable or fixed television, personal computer, digital camera, digital camcorder, portable audio device, portable or fixed analog or digital radio, or combinations thereof, are in communication with a network 118. The network 118 may include a broadcast network and/or cellular network. A cellular network may include a wireless network and a base transceiver station transmitter. The cellular network may include a second/third-generation (2G/3G) cellular data communications network, a Global System for Mobile communications network (GSM), or other wireless communication network such as a WLAN network. The mobile device 112 may comprise a digital broadcast receiver device.

In one aspect of the invention, mobile device 112 may include a wireless interface configured to send and/or receive digital wireless communications within network 118. The information received by mobile device 112 through the network 118 includes user selection, applications, services, electronic images, audio clips, video clips, and/or WTAI (Wireless Telephony Application Interface) messages.

A server such as server 126 may act as a file server, such as a personal server for a network such as home network, some other Local Area Network (LAN), or a Wide Area Network (WAN). Server 126 may be a computer, laptop, set-top box, DVD, television, PVR, DVR, TiVo device, personal portable server, personal portable media player, network server or other device capable of storing, accessing and processing data. Mobile device 112 may communicate with server 126 in a variety of manners. For example, mobile device 112 may communicate with server 126 via wireless communication.

In another aspect of the invention, a server such as server 127 may alternatively (or also) have one or more other communication network connections. For example, server 127 may be linked (directly or via one or more intermediate networks) to the Internet 129, to a conventional wired telephone system, or to some other communication or broadcasting network, such as a TV, a radio or IP datacasting networks.

In an embodiment, mobile device 112 has a wireless interface configured to send and/or receive digital wireless communications within wireless network 118. As part of wireless network 118, one or more base stations (not shown) may support digital communications with mobile device 112 while the mobile device 112 is located within the administrative domain of wireless network 118. Mobile device 112 may also be configured to access data previously stored on server 126. In one embodiment, file transfers between remote control device 112 and server 126 may occur via Short Message Service (SMS) messages and/or Multimedia Messaging Service (MMS) messages transmitted via short message service center (SMSC) and/or a multimedia messaging service center (MMSC). The transfer may also occur via IMS or over standard Internet Protocol (IP) stack.

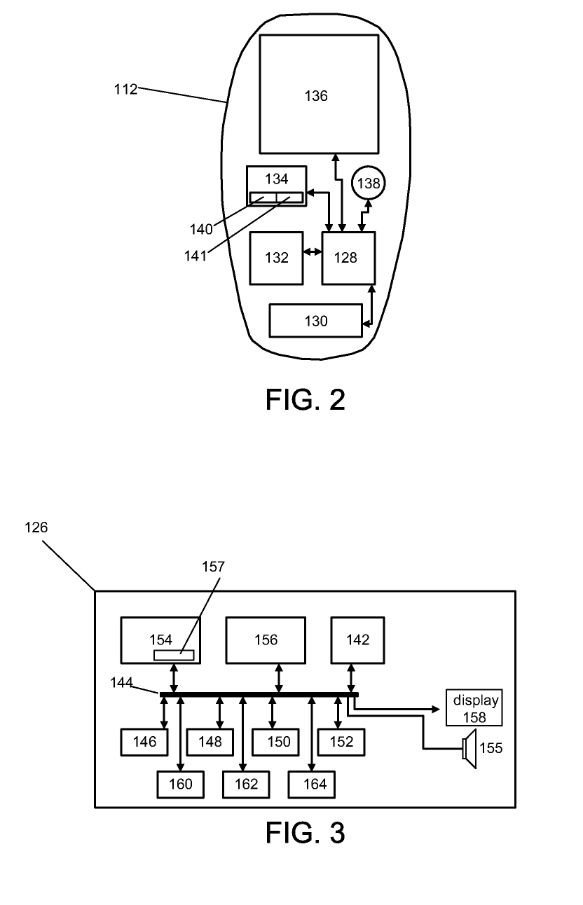

As shown in FIG. 2, mobile device 112 may include processor 128 connected to user interface 130, wireless communications interface 132, memory 134 and/or other storage, display 136, and digital camera 138. User interface 130 may further include a keypad, four arrow keys, joy-stick, data glove, mouse, roller ball, touch screen, voice interface, or the like. Software 140 may be stored within memory 134 and/or other storage to provide instructions to processor 128 for enabling remote control device 112 to perform various functions. For example, software 140 may include an ASR client 141. Other software may include software to automatically name a photograph, to save photographs as image files, to transfer image files to server 114, to retrieve and display image files from server 126, and to browse the Internet using communications interface 132. Although not shown, communications interface 132 could include additional wired (e.g., USB) and/or wireless (e.g., BLUETOOTH, WLAN, WiFi or IrDA) interfaces configured to communicate over different communication links.

As shown in FIG. 3, server 126 may include processor 142 coupled via bus 144 to one or more communications interfaces 146, 148, 150, and 152. Interface 146 may be a cellular telephone or other wireless network communications interface. There may be multiple different wireless network communication interfaces. Interface 148 may be a conventional wired telephone system interface. Interface 150 may be a cable modem. Interface 152 may be a BLUETOOTH interface or any other short range wireless connection interface. Additionally, there may be multiple different interfaces. FIG. 3 also illustrates receiver devices such as receiver devices 160, 162, and 164. Receiver device 162 may comprise a television receiver configured to receive and decode transmissions based on Digital Video Broadcast (DVB) standard. Receiver 162 may include a radio receiver such as a FM radio receiver to receive and decode FM radio transmissions. Receiver 164 may comprise an IP datacasting receiver.

Server 126 may also include volatile memory 154 (e.g., RAM) and/or non-volatile memory 156 (such as a hard disk drive, tape system, or the like). Software and applications may be stored within memory 154 and/or memory 156 that provides instructions to processor 142 for enabling server 126 to perform various functions, such as processing file transfer requests (such as for image files), storing files in memory 154 or memory 156, displaying images and other data, and organizing images and other data. The other data may include but is not limited to video files, audio files, emails, SMS/MMS messages, other message files, text files, or presentations. In one aspect of the invention, memory 154 may include a DSR client 157. The DSR client 157 may covert an incoming stream from an ASR engine into recognized text.

Although shown as part of server 126, memory 156 could be remote storage coupled to server 126, such as an external drive or another storage device in communication with server 126. Preferably, server 126 also includes or is coupled to a display device 158 that may have a speaker 155, via a video interface (not shown). Display 158 may be a computer monitor, a television set, a LCD projector, or other type of display device. In at least some embodiments, server 126 also includes a speaker 155 over which audio clips (or audio portions of video clips) stored in memory 154 or 156 may be played.

In an aspect of the invention, a user may record some speech on his/her mobile device using a mobile device-based ASR application. When the user reaches his/her home/office they may begin to use an ASR application present on his/her PC/Laptop seamlessly. Thus, the user utilizes the mobility of his/her mobile device when he/she is on the move and avails the higher resources available to his/her PC-based ASR engine. In another aspect of the invention, a user may seamlessly move between different environments. For example, a first environment may include a noisy hallway, whereas, a second environment may comprise a quite office. In an embodiment, a first ASR engine used in the first environment (noisy hallway) may be tuned for a high ambient noise environment, whereas, a second ASR engine employed in the second environment (quite office) may be tuned for a lower ambient noise level. As the user moves from the first environment to the second environment, the ASR session may be transferred seamlessly without user knowledge that the ASR session has been transferred from the first ASR engine to the second ASR engine.

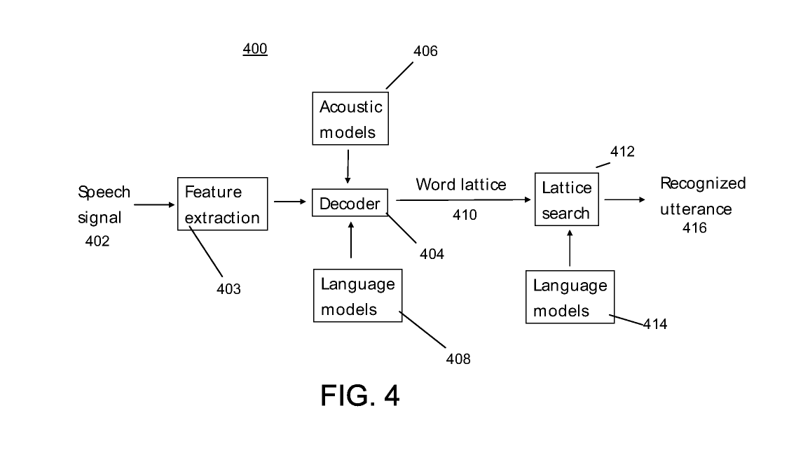

Speech recognition systems provide the most probable decoding of the acoustic signal as the recognition output, but keep multiple hypotheses that are considered during the recognition. FIG. 4 shows a block diagram of a speech recognition system 400 in accordance with an aspect of the invention. In FIG. 4, a speech signal 402 may be presented to a speech recognition system 400 in which a feature extraction tool 403 may be used to extract various features from speech signal 402. A decoder 404 receiving inputs from acoustic models 406 and language models 408 may be used to generate a word lattice representation 410 of the speech signal. The acoustic models 406 may indicate how likely it is that a certain word corresponds to a part of the speech signal. The language models 408 may be statistical language models and indicate how likely a certain word may be spoken next, given the words recognized so far by decoder 404. A word lattice which may be a set of transition weights for various hypothesized sequence of words may be generated and searched 412 with input from additional language models 414 to determine a recognized utterance 416.

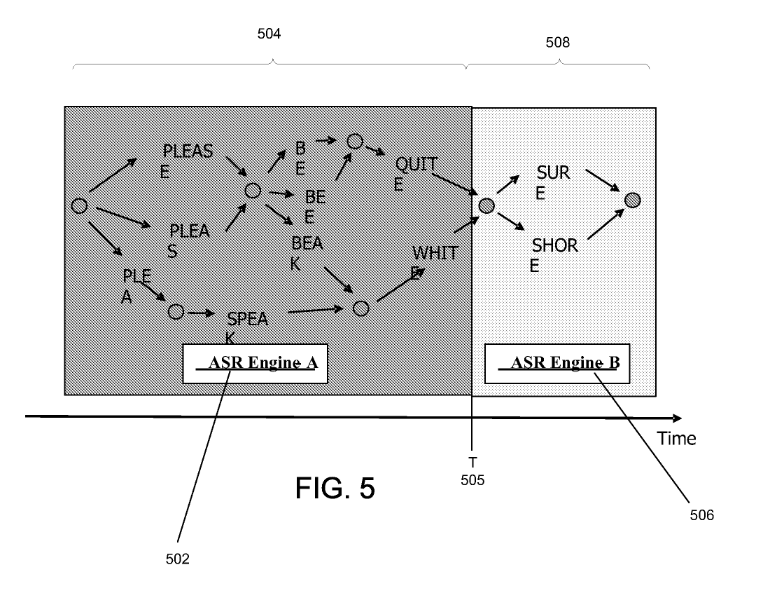

FIG. 5 shows a word lattice that may be constructed for a phrase such as “please be quite sure” together with multiple hypotheses considered during recognition in accordance with an aspect of the invention. The multiple hypotheses at a given time, often known as N-best word lists, may provide grounds for additional information that may be used by another application or another ASR engine. As those skilled in the art will realize, recognition systems generally have no means to distinguish between correct and incorrect transcriptions, and a word lattice representation is often used to consider all hypothesized word sequences within the context.

In FIG. 5, the nodes represent points in time, and the arcs represent the hypothesized word with an associated confidence level (not shown in FIG. 5). The path with the highest confidence level is generally provided as the final recognized result, often known as the 1-best word list. The lattice may be stored in the memory of an ASR engine. In addition, the arcs/nodes of the lattice contain the acoustic and language model scores of the currently active ASR engine. Furthermore, the lattice may include additional information such as speaker identity and language identity.

As illustrated in FIG. 5, a first ASR engine A “502” may be used by a user for speech recognition services. During use of the first ASR engine A “502”, a portion of the speech or phrase “please be quite sure” may be recognized 504 by the first ASR engine A “502.” At a time “T” 505 a transition from a first ASR engine A “502” to a second ASR engine B “506” may be initiated. The second ASR engine B “506” may continue to seamlessly recognize 508 the remaining portion of the phrase “please be quite sure” with or without user knowledge of the transition.

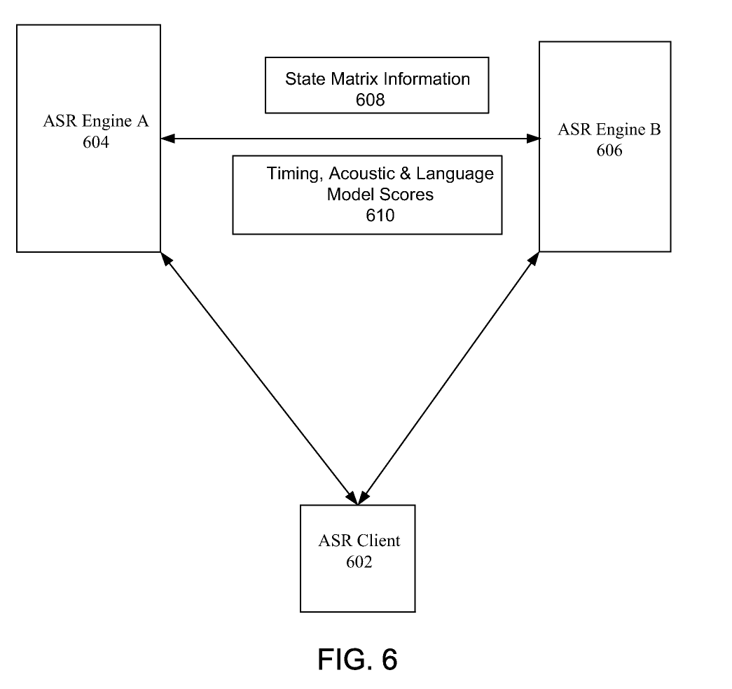

FIG. 6 illustrates exemplary switching from a first ASR engine to second ASR engine in accordance with at least one aspect of the invention. In FIG. 6, an ASR client 602 may be a mobile device such as a PDA and/or phone or even a person speaking in a smart space/pervasive computing environment. ASR engines A “604” and B “606” may be two nodes in the user's resource network. In an aspect of the invention, each of the ASR engines 604 and 606 may store state information for each of the received samples of speech which may be used to generate a state matrix. The state matrix may be used to recognize speech and output the speech in digital (typically text) format. When a session is transferred from ASR engine A “604” to ASR engine B “606,” state matrix information that ASR engine A “604” has generated based on the speech data received until that point in time is transferred to ASR engine B “606” which allows ASR engine B “606” to start from that point onwards and does not require the data that was received by ASR engine A “604” before the session transfer.

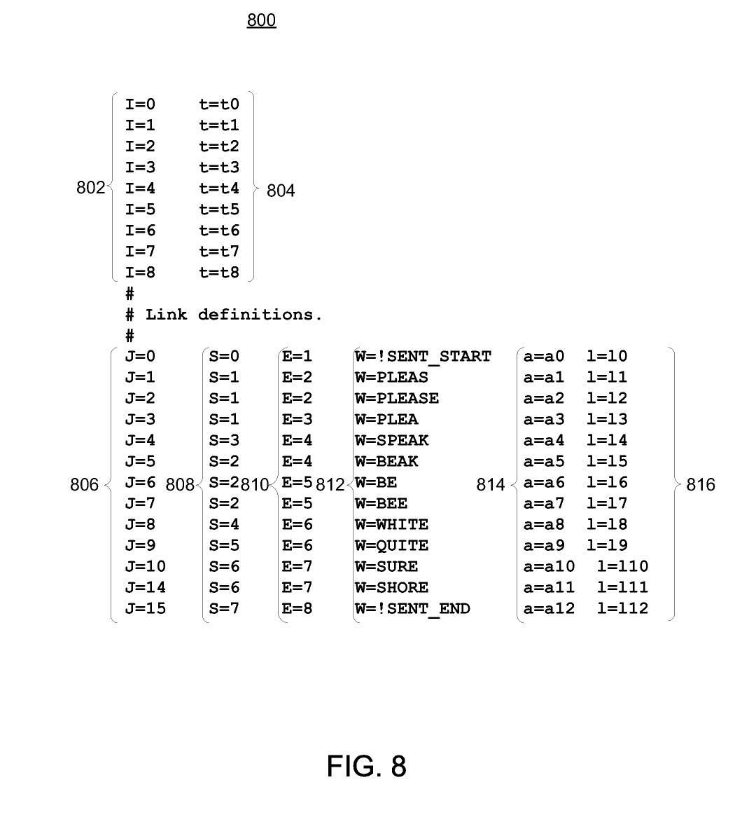

Exemplary lattice and state information is illustrated in FIG. 8 in accordance with an aspect of the invention. As shown in FIG. 8, lattice and state information 800 may be stored and transferred from a first ASR engine to a second ASR engine for seamless automatic transfer of speech recognition services. The lattice and associated state information 800 may contain numerous fields such as a node identifier field “I” 802, a time from start of utterance field “t” 804, a link identifier field “J” 806, a start node number (of the link) field “S” 808, an end node number (of the link) field “E” 810, a word associated with link field “W” 812, an acoustic likelihood of link field “a” 814, and a general language model likelihood field “1” 816. Those skilled in the art will realize that FIG. 8 and the represented data merely represent one exemplary form of state information. In addition, those skilled in the art will also realize that other additional or different fields may also be included with the lattice and/or state information.

In an aspect of the invention, timing information along with the acoustic and language model scores may be transferred to the ASR engine B “606” from ASR engine A “604.” In an embodiment, if the speech signal is saved in the memory of the ASR engine for every utterance, the speech signal may also be transferred depending on the bandwidth and quality of the connection between the ASR engines.

In an aspect of the invention, each of the ASR engines may use its own set of acoustic and language models to rescore the word lattice. As those skilled in the art will realize, the receiving or second ASR engine may use the acoustic models to rescore the lattice only if the speech data is available. If the recorded speech signal from the beginning of the sentence or phrase is not available, then it may be the case that only timing information is used and the new engine uses its own language model and the acoustic score from the lattice to find the spoken utterance. In addition, the lattice may not be encoded with words alone; it may also contain other acoustic information carried by the speech signal, such as prosody, speaker identity and language identity.

In an aspect of the invention, an ASR session transfer between the two ASR engines may include session establishment and context information transfer. In session establishment, standard signaling protocols like HTTP/SIP/etc may be used to provide the high-level framework to establish a session. This may provide for parameter negotiation before establishment and could be used to agree on the formats or syntax to be used to transport and interpret the context information from one ASR engine to another. In another aspect of the invention, session establishment may also include verifying the usefulness of first ASR engine's context information to the second ASR engine.

In another aspect of the invention, context information transfer may include formatting lattice information in a mutually agreed syntax and format. The lattice information may be transferred from one ASR engine to another using any commonly used representation techniques such as SDP, XML, ASCII-Text file, or any other format deemed suitable by the two engines involved in the session transfer.

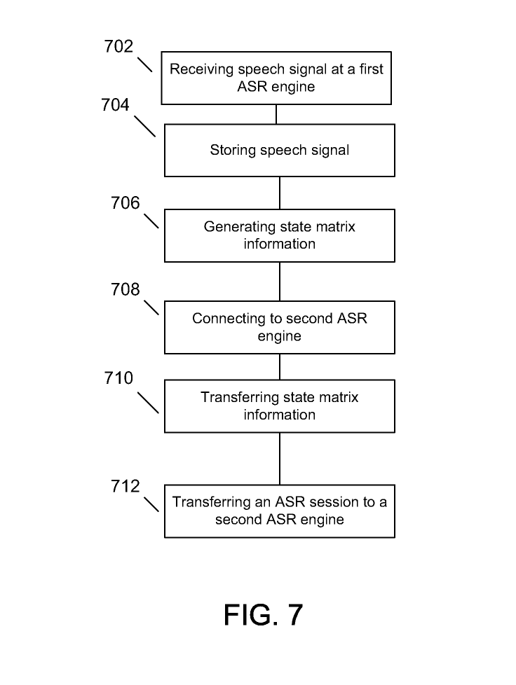

FIG. 7 illustrates a flow diagram illustrating the transfer from a first ASR engine to a second ASR engine in accordance with an aspect of the invention. In FIG. 7, a speech signal may be received at an ASR engine in step 702. Next, in step 704 the speech signal may be saved in memory. In step 706, a state information matrix may be generated based on the received speech signal. Next, in step 708 a connection may be established to a second ASR engine based on a transfer of the ASR session. The state matrix information generated by the first ASR engine may be transferred to the second ASR engine in step 710. Finally, in step 712 the ASR session may be transferred to the second ASR engine which may begin at the point where the first ASR engine finished providing a seamless transition.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques.

We claim:

1. A method comprising:
receiving a speech signal at a first engine during an ASR session;
storing the speech signal;
generating state matrix information, the state matrix information based on the received speech signal;
connecting to a second engine;
transferring the generated state matrix information to the second engine; and
transferring the ASR session to the second engine.

2. The method of claim 1, wherein the first and second engines comprise ASR engines.

3. The method of claim 1, further comprising transferring timing information along with the generated state matrix information.

4. The method of claim 1, further comprising transferring acoustic and language model scores along with the generated state matrix information.

5. The method of claim 1, further comprising transferring the stored speech signal along with the generated state matrix information.

6. A method comprising:
receiving a speech signal at a first engine during an ASR session;
storing the speech signal;
generating a word lattice representation;
storing the generated word lattice;
generating state matrix information, the state matrix information based on the received speech signal;
connecting to a second engine;
transferring the generated state matrix information and the word lattice representation to the second engine; and
transferring the ASR session to the second engine.

7. The method of claim 6, wherein the first and second engines comprise ASR engines.

8. The method of claim 6, further comprising transferring timing information along with the generated state matrix information.

9. The method of claim 6, further comprising transferring acoustic and language model scores along with the generated state matrix information.

10. The method of claim 6, further comprising transferring the stored speech signal along with the generated state matrix information.

11. The method of claim 6, wherein the second engine scores the word lattice representation.

12. The method of claim 11 wherein the scoring of the word lattice representation is based on acoustic and language models stored in the second engine.

13. An apparatus comprising:
a communication interface;
a receiver;
a transmitter;
a storage medium; and
a processor coupled to the storage medium and programmed with computer-executable instructions to perform the steps comprising:
receiving a speech signal for use in an automatic speech recognition service during an ASR session;
storing the speech signal;
generating a word lattice representation;
storing the generated word lattice representation;
generating state matrix information, the state matrix information based on the received speech signal;
receiving a signal to transfer the ASR session; and
transmitting the generated state matrix information to continue the ASR session.

14. The apparatus of claim 13, further comprising transmitting timing information along with the generated state matrix information.

15. The apparatus of claim 13, further comprising transmitting acoustic and language model scores along with the generated state matrix information.

16. The apparatus of claim 13, further including transmitting the stored speech signal along with the generated state matrix information.

17. An apparatus comprising:
a communication interface;
a receiver;
a transmitter;
a storage medium; and
a processor coupled to the storage medium and programmed with computer-executable instructions to perform the steps comprising:
receiving state matrix information from an ASR session;
receiving word lattice information from the ASR engine;
storing the received state matrix information and the word lattice information;
scoring the word lattice information using acoustic and language models;
receiving a speech signal; and
continuing the ASR session based on the received speech signal.

18. The apparatus of claim 17, further comprising receiving timing information along with the state matrix information.

19. The apparatus of claim 17, further comprising receiving acoustic and language model scores along with the state matrix information.

20. The apparatus of claim 17, further including receiving a signal corresponding to the state matrix information along with the state matrix information.

21. The apparatus of claim 17, wherein the apparatus comprises a mobile computing device.

22. The apparatus of claim 21, wherein the mobile computing device comprises a mobile telephone.

23. The apparatus of claim 17, wherein the lattice information includes speaker identity and language identity.

24. The apparatus of claim 21, further including receiving a speech signal along with the state matrix information.

25. A system for automatic speech recognition, the system comprising:
a first ASR engine for use during an ASR session; and
a second ASR engine, the second ASR engine continuing from the point where the first ASR engine transferred the ASR session.

26. The system of claim 25 wherein the first ASR session establishes a connection with the second ASR engine with a signaling protocol.

27. The system of claim 25 wherein the first ASR engine transmits state matrix information to the second ASR engine.

28. The system of claim 27, wherein the first ASR engine transmits timing information along with the state matrix information to the second ASR engine.

29. The system of claim 27, wherein the first ASR engine transmits a speech signal along with the state matrix information to the second ASR engine.

30. The system of claim 27, wherein the second ASR engine scores a word lattice received from the first ASR engine.
